(19) United States
(12) Patent Application Publication
(10) Pub. No.: US 2014/0204091 A1
(43) Pub. Date: Jul. 24, 2014

(54) AUTOMATED CELL TOWER SECTOR AND CALL DATA RECORD PLOTTING TOOL

(71) Applicant: METROPCS WIRELESS, INC., Richardson, TX (US)

(72) Inventor: TIMOTHY A. LOWNDES, TYLER, TX (US)

(73) Assignee: METROPCS WIRELESS, INC., RICHARDSON, TX (US)

(21) Appl. No.: 13/747,663

(22) Filed: Jan. 23, 2013

(51) Int. Cl. G06T 11/20

(52) U.S. Cl. CPC G06T 11/206
USPC 345/440

(57) ABSTRACT

A method for generating a plot of cell towers and associated sectors on a map includes the steps of determining a position of at least one cell tower on a map responsive to data indicating a position of the cell tower and determining boundaries associated with a plurality of sectors associated with the at least one cell tower responsive to an azimuth associated with each of the plurality of sectors. A location of call events are also determined responsive to call data. A plot of the map is generated including the at least one cell tower, the boundaries associated with the plurality of sectors associated with the at least one cell tower and the location of the call events marked on the map.

### TECHNICAL FIELD

The present invention relates to the plotting of cell towers, associated cell sectors and call data records upon a map, and more particularly, to a system for automatically plotting cell towers, associated cell tower sectors and call data records upon a map to provide a graphical representation of the towers and associated sectors.

### BACKGROUND

Many times in a litigation, corporate due diligence or other legal-related matters, there is a need to display information on a map with respect to cell tower sites, the various sectors associated with these cell tower sites and information with respect to calls occurring in the area of the cell tower. Present techniques require an individual to obtain a copy of a map with respect to a particular area and hand plot the position of a cell tower or towers upon the map and any relevant call information. The various sectors and sector boundaries that are associated with the cell tower are hand-drawn onto the map to provide a visual representation of the cell tower and associated sectors. Information from call data records must also be hand-plotted onto the map. This process is very time-consuming in order to exactly place the cell tower sites, generate the various sectors that are associated with the cell towers and place the call record information. Thus, some manner for enabling an individual to quickly and efficiently plot location information with respect to cell towers, cell tower sectors and call records would be of great benefit in the situations where litigation or other legal matter required the use of such information within the proceeding.

### SUMMARY

The present invention, as disclosed and described herein, in one aspect thereof comprises a method for generating a plot of cell towers and associated sectors on a map. The method determines a position of at least one cell tower on a map responsive to data indicating a position of the cell tower and determines boundaries associated with a plurality of sectors associated with the at least one cell tower responsive to an azimuth associated with each of the plurality of sectors. A location of call events are also determined responsive to call data. A plot of the map is generated including the at least one cell tower, the boundaries associated with the plurality of sectors associated with the at least one cell tower and the location of the call events marked on the map.

### BRIEF DESCRIPTION OF THE DRAWINGS

For a more complete understanding, reference is now made to the following description taken in conjunction with the accompanying Drawings in which:

FIG. 1 illustrates the manner in which a plotting tool may be used to generate cell tower and sector boundary plots based on various input information;

FIG. 2a is a functional block diagram of the cell tower and sector plotting tool;

FIG. 2b illustrates a cell tower list;

FIG. 2c illustrates a call data record;

FIG. 2d illustrates an alternative embodiment of the cell tower and sector plotting tool;

FIG. 3 illustrates the use of a cell tower and sector plotting tool within personal computer software;

FIG. 4 illustrates the use of a cell tower and sector plotting application as a mobile device application;

FIG. 5 illustrates the use of a cell tower plotting application that is remotely accessed via a network such as the internet;

FIG. 6 is a flow diagram describing the operation of the cell tower and sector plotting system;

FIG. 7 illustrates a first example of a plot of a cell tower and associated sectors;

FIG. 8 illustrates a further example showing a map including several cell towers of different types with the associated sectors plotted on the map in association with the cell towers; and

FIG. 9 illustrates a map plot including information from call detail records.

### DETAILED DESCRIPTION

Referring now to the drawings, wherein like reference numbers are used herein to designate like elements throughout, the various views and embodiments of an automated cell tower sector plotting tool are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

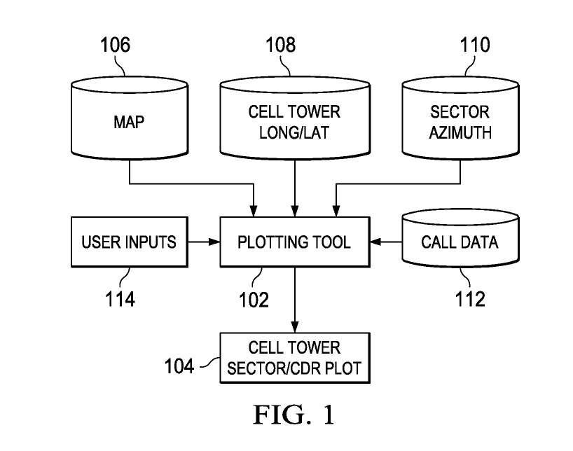

Referring now to the drawings, and more particularly to FIG. 1, there is illustrated a manner in which a plotting tool 102 may be utilized to provide a cell tower/sector/call data record plot 104. The cell tower/sector plot 104 comprises a map that has included thereon one or more cell tower sites. Each of these cell tower sites has one or more sectors associated therewith and the cell tower/sector/call data record plot 104 displays the boundaries of these sectors such that the cell tower/sector plot 104 may be used as a visual aid within a legal or corporate proceeding. The plotting tool 102 generates the cell tower/sector plot 104 using a variety of information that is input into the plotting tool 102. The first thing that is needed is some type of map data 106. The map data 106 can be information provided from, for example, Google or some other type of mapping application that provides street-level detail of a particular area of interest.

The cell tower longitude/latitude data 108 comprises longitude and latitude coordinates for each cell tower that a user desires to include upon the associated mapping data 106. Additionally, cell sector azimuth data 110 is provided for each of the cell towers that are to be mapped that indicate the azimuth direction of each sector associated with a particular cell tower. The sector azimuth information may comprise the azimuth for one or more sectors for each cell tower depending upon the type of cell tower that is involved. The plotting tool 102 processes the cell tower longitude/latitude data 108 and the sector azimuth data 110 to generate a map that includes each cell tower plotted thereon and further has the sectors associated with each of the cell towers illustrated on the map with respect to the approximate boundaries of these sectors. The cell towers are placed using the longitude and latitude of each tower. The azimuth for each sector is used for calculating the boundaries for each of the sectors of the cell tower. All of this information is provided on the cell tower/sector plot 104.

Various call data records 112 may then be imported onto the plot 104 to represent and plot locations from which calls have been made. The call data records 112 may include information such as per call measurement data (PCMD) or call detail records (CDR). The call data records 112 are used to plot the call related information onto the map with the plotted cell towers. The plotting tool 102 additionally has the ability to receive various user inputs 114 that allows the user to place particular icons or information upon the cell tower sector plot 104 that delineates or highlights particular information which an individual desires to illustrate or bring out upon the cell tower sector plot map 104 that has been created.

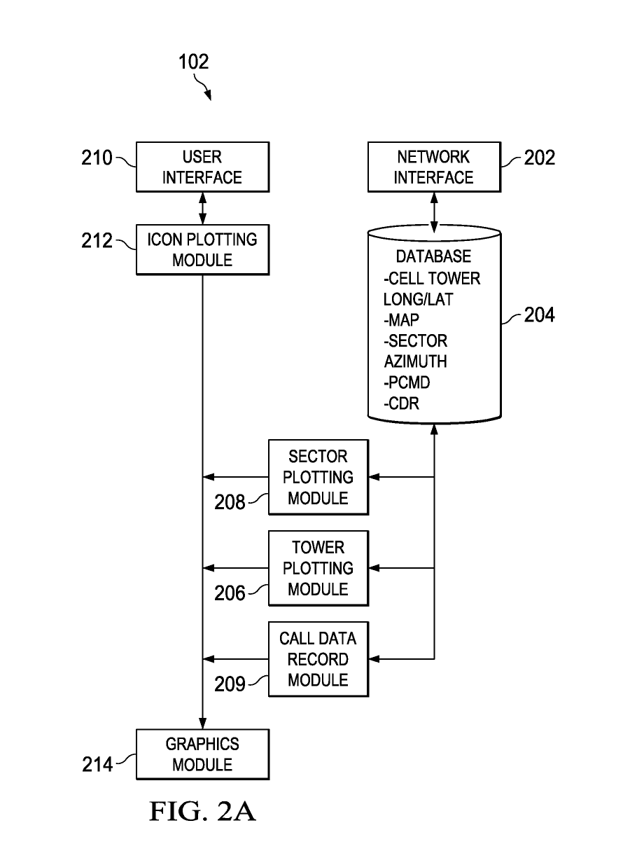

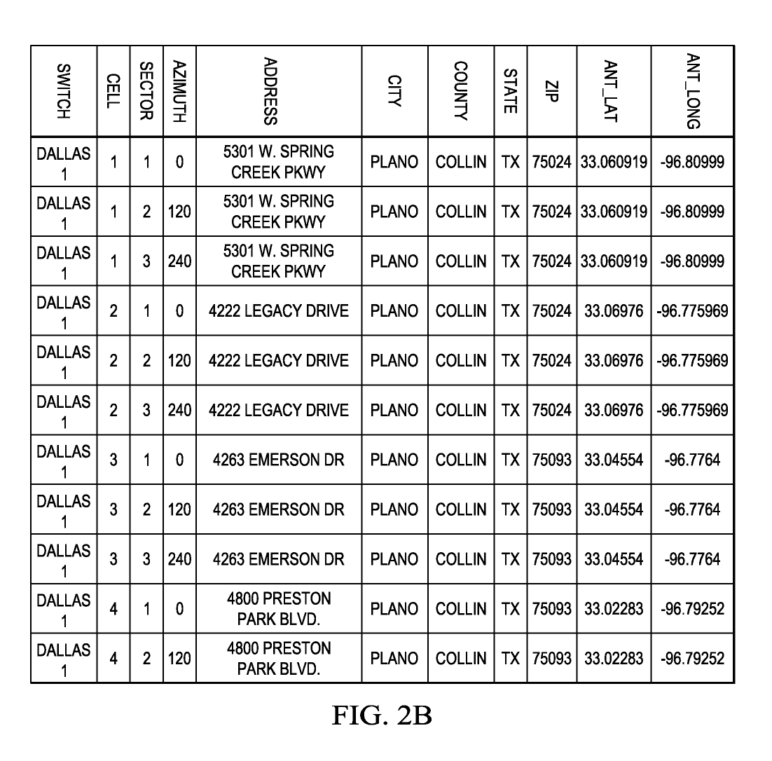

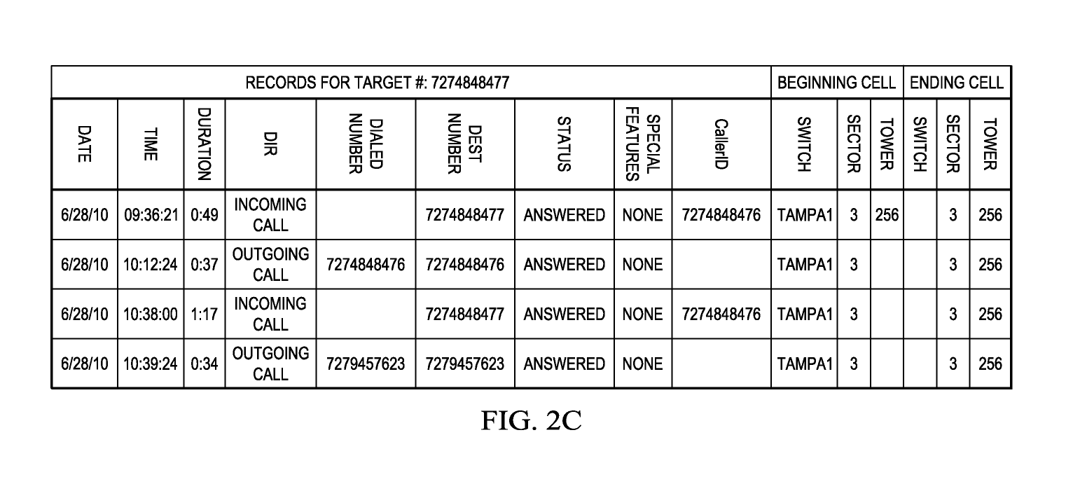

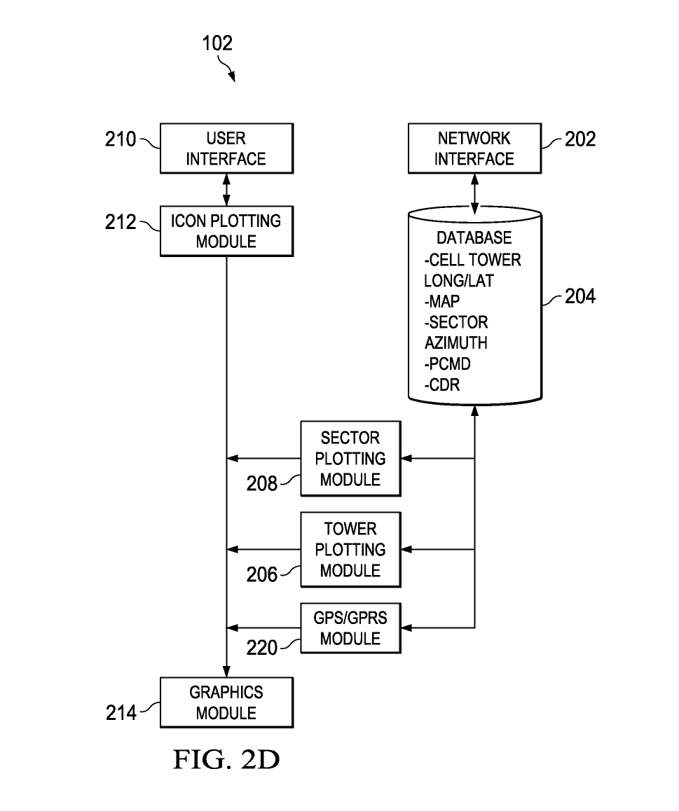

Referring now to FIG. 2a, there is illustrated a functional block diagram of the plotting tool 102. The plotting tool 102 includes a network interface 202 that enables the downloading of information into a database 204 through a connected network such as the internet. The database 204 is used for storing information that is used to plot out the cell tower sector plots 104 such as the cell tower longitude/latitude information, the map data, the sector azimuth data and call data information such as PCMD and CDR. All the information within the database 204 can be previously stored within the database 204 or may be downloaded to the database 204 through the network interface 202 as needed.

Various plotting modules utilize the data stored within the database 204 to create the cell tower/sector plot 104. A tower plotting module 206 combines the cell tower longitude/latitude information within the database 204 with the map data contained within the database 204 to plot the positions of the cell tower upon the geographic area illustrated by the map data. The cell tower information may be provided via a spread sheet that can be automatically uploaded into the database 204 by having correlated data fields. A single or group of towers may be manually uploaded into the database by providing tower switch and number of the targeted tower; the latitude and longitude of the tower; and the azimuth of each sector on the tower. One example of a tower list is illustrated below in FIG. 2b.

The sector plotting module 208 uses the sector azimuth data within the database 204, the cell tower longitude/latitude information within the database 204 and the map data within the database 204 to plot the boundaries of each of the sectors associated with the various cell towers that have been plotted by the tower plotting module 206. The sector plotting module 206 plots out the various sectors and defines their boundaries with respect to each cell tower. The sector plotting module 206 uses the azimuth of each sector and the following to plot the sectors.

Not all sectors are adjoined by a sequential sector number but all azimuths are shown by their compass heading. Adjoining sectors will be the azimuth of the lowest increased number on the compass as you move from sector to sector around the tower in a clockwise direction. Each sector will have two boundary lines showing the approximate range of coverage of the sector. To determine the first boundary line of a sector you take the sectors azimuth and subtract that number from the next adjoining sector azimuth. This will be the next lowest increased azimuth number on the compass. This result is divided by 2 then added to that sectors azimuth to reveal the first boundary line of the sector. This process is repeated until all sector boundary lines have been calculated for the cell tower. This process will also show the sector sequential order on the tower.

The call data record module 209 is used for importing and plotting information relating to call data records into the map. The call data records may be in the format of per call measurement data (PCMD) or call detail records (CDR). This allows information with respect to a particular call to be displayed on the map. The call data module 209 plots information relating to when and where calls were made with respect to a particular cell tower on a map plot that is being created. An example of a CDR is illustrated in FIG. 2c.

A user interface 210 enables a user to manually enter information to be included within the plot generated by the plotting tool 102. The user interface 210 may comprise a user keyboard/mouse combination or some other type of data entry device enabling the user to access the icon plotting module 212. The icon plotting module 212 enables a user through the user interface 210 to place particular icons or items of interest that are to be highlighted within the cell tower sector plots being generated. This information is placed within the sector plot by the icon plotting module 212.

The information generated by the tower plotting module 206, the sector plotting module 208, the call data record module 209 and the icon plotting module 212 are utilized by a graphics module 214 in order to generate the cell tower sector/CDR plot 104 including all of the information with respect to the cell towers that are located within a particular mapped area, the sectors that are associated with these cell towers and the calls that occurred within the area of the cell towers. The graphics module 214 enables the generation of the map represented by the mapping data and illustrates each of the cell towers within the mapped area, shows the sectors and approximate sector boundaries that are associated with these various cell towers and illustrates various calls that occurred within these areas as will be more fully described herein below.

Referring now to FIG. 2d, there is illustrated a functional block diagram of an alternative embodiment of the plotting tool 102. The major difference between this embodiment and that of FIG. 2a is a GPS/GPRS module 220 that replaces the Call data record module of FIG. 2a. It should also be realized that both a Call Data Record module 209 and a GPS/GPRS module 220 could each be included in the same plotting tool 102. The plotting tool 102 includes a network interface 202 that enables the downloading of information into a database 204 through a connected network such as the internet. The database 204 is used for storing information that is used to plot out the cell tower sector plots 104 such as the cell tower longitude/latitude information, the map data, the sector azimuth data and call data information such as GPS (global positioning system) data or GPRS (general packet radio service) data. All the information within the database 204 can be previously stored within the database 204 or may be downloaded to the database 204 through the network interface 202 as needed.

Various plotting modules utilize the data stored within the database 204 to create the cell tower/sector plot 104. A tower plotting module 206 combines the cell tower longitude/latitude information within the database 204 with the map data contained within the database 204 to plot the positions of the cell tower upon the geographic area illustrated by the map data. The cell tower information may be provided via a spread sheet that can be automatically uploaded into the database 204 by having correlated data fields. A single or group of towers may be manually uploaded into the database by providing tower switch and number of the targeted tower; the latitude and longitude of the tower; and the azimuth of each sector on the tower.

The sector plotting module 208 uses the sector azimuth data within the database 204, the cell tower longitude/latitude information within the database 204 and the map data within the database 204 to plot the boundaries of each of the sectors associated with the various cell towers that have been plotted by the tower plotting module 206. The sector plotting module 206 plots out the various sectors and defines their boundaries with respect to each cell tower. The sector plotting module 206 uses the azimuth of each sector and the following to plot the sectors.

Not all sectors are adjoined by a sequential sector number but all azimuths are shown by their compass heading. Adjoining sectors will be the azimuth of the lowest increased number on the compass as you move from sector to sector around the tower in a clockwise direction. Each sector will have two boundary lines showing the approximate range of coverage of the sector. To determine the first boundary line of a sector you take the sectors azimuth and subtract that number from the next adjoining sector azimuth. This will be the next lowest increased azimuth number on the compass. This result is divided by 2 then added to that sectors azimuth to reveal the first boundary line of the sector. This process is repeated until all sector boundary lines have been calculated for the cell tower. This process will also show the sector sequential order on the tower.

The GPS/GPRS module 220 is used for importing and plotting information relating to GPS and/or GPRS data into the map. This allows information with respect to a particular call to be displayed on the map. The GPS/GPRS module 209 plots information relating to when and where calls were made with respect to a particular cell tower on a map plot that is being created.

A user interface 210 enables a user to manually enter information to be included within the plot generated by the plotting tool 102. The user interface 210 may comprise a user keyboard/mouse combination or some other type of data entry device enabling the user to access the icon plotting module 212. The icon plotting module 212 enables a user through the user interface 210 to place particular icons or items of interest that are to be highlighted within the cell tower sector plots being generated. This information is placed within the sector plot by the icon plotting module 212.

The information generated by the tower plotting module 206, the sector plotting module 208, the GPS/GPRS module 220 and the icon plotting module 212 are utilized by a graphics module 214 in order to generate the plot 104 including all of the information with respect to the cell towers that are located within a particular mapped area, the sectors that are associated with these cell towers and the calls that occurred within the area of the cell towers. The graphics module 214 enables the generation of the map represented by the mapping data and illustrates each of the cell towers within the mapped area, shows the sectors and approximate sector boundaries that are associated with these various cell towers and illustrates various calls that occurred within these areas as will be more fully described herein below.

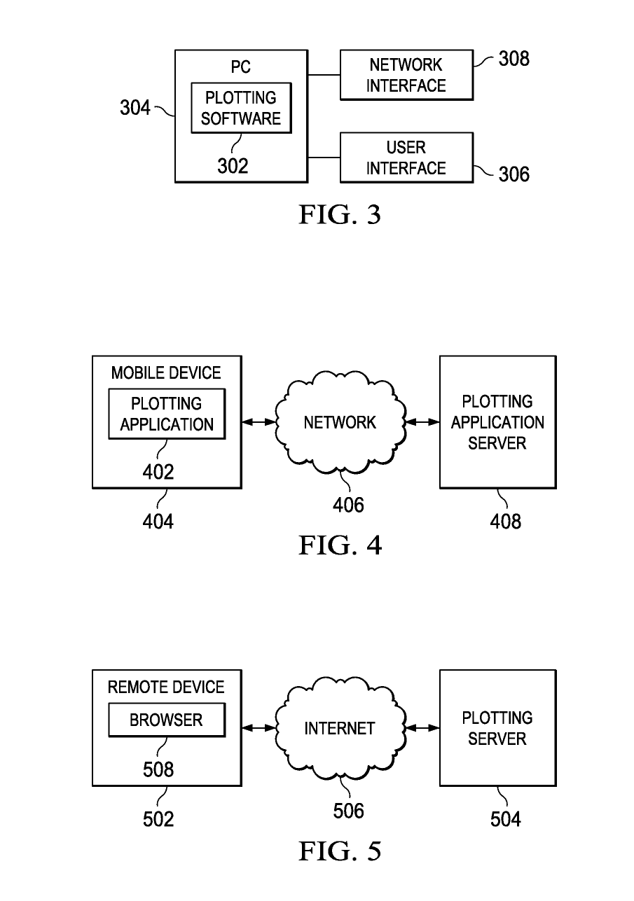

Referring now to FIGS. 3-5, there are illustrated various manners for implementing the plotting system described with respect to FIG. 2 in various operating environments. Referring now to FIG. 3, there is illustrated the plotting software 302 implemented as software on a personal computer or other type of computing device. The plotting software 302 would be installed upon the personal computer 304 as software is normally done and access to the plotting software would be achieved through a user interface 306 and network interface 308. The user interface 306 would be used for launching the software and designating the particular maps, cell towers and information that is to be generated with a particular cell tower sector plot. The network interface 308 can be used for downloading the information such as the map data, cell tower longitude and latitude location data and the sector azimuth data associated with a plot.

Alternatively, as illustrated in FIG. 4, the plotting tool could be implemented as a plotting application 402 upon some type of mobile device such as a Smartphone, mobile phone, tablet or other type of mobile computing device 404. In this case, the mobile device would obtain the various plotting information through an associated network 406 such as the internet that communicates with a plotting application server 408. The plotting application 402 would establish a connection with the plotting application server 408 over the network 406 and provide the plotting application server 408 with various parameters indicating the information that the user of the mobile device 404 wanted to include within a particular cell tower sector plot. The plotting application server 408 gathers the appropriate information such as the map data, cell tower data, and sector azimuth data, generates the necessary plots and provides this back to the plotting application 402 through the network 406. Alternatively, the user could have some of the map data, cell tower longitude and altitude location data and sector azimuth data within the mobile device 404 and provides this to the plotting application server 408 over the network 406 rather than having the plotting application server 408 obtains this information.

Referring now to FIG. 5, there is illustrated a further embodiment wherein a remote device such as a computer, mobile device, tablet PC, etc., accesses a plotting server 504 through the internet 506 utilizing a browser 508 within the remote device 502. In this case, the browser 508 merely accesses a website provided by the plotting server 504 over the internet 506 and enters the relevant map cell tower longitude and latitude data and sector azimuth data into the plotting server 504 or instructs the plotting server 504 to obtain the necessary information. The plotting server 504 generates the appropriate cell tower sector plots and this information is downloaded to the remote device 502 and stored thereon over the internet 506. Thus as can be seen from the descriptions with respect to FIGS. 3-5, the cell tower sector plotting tool for automatically generating the sector boundary plots can be implemented in a number of fashions, whether as standalone software, mobile device apps or using the browser of a remote device to access a remote web location. Other types of implementation would be readily apparent to one skilled in the art.

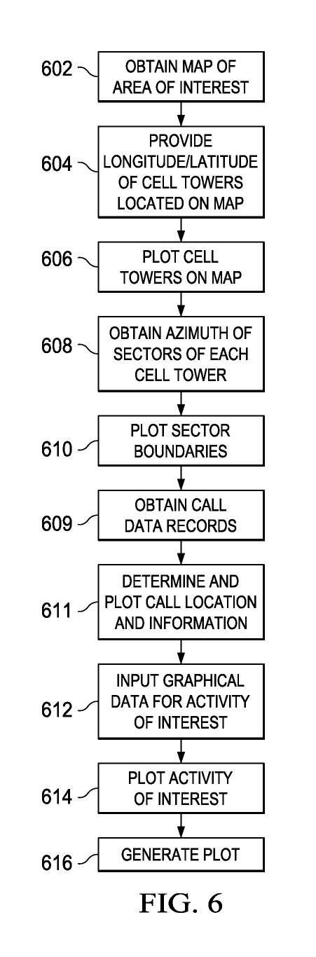

Referring now to FIG. 6, there is illustrated a flow diagram describing the operation of the cell tower sector plotting tool that has been described hereinabove. Initially, data associated with a map of a particular area of interest is obtained at step 602. As discussed previously, this can be information provided by the user or downloaded from such internet mapping functions as Google Earth, MapQuest, Google Maps, etc. Next, the longitude and latitude locations of each cell tower located on the map are provided to the plotting tool. This information is utilized by the plotting tool to plot the locations of the cell towers at the geographic location on the map at step 606. Next, the azimuths of each sector associated with each cell tower that was plotted at step 606 are provided to the plotting tool at step 608. Each cell tower may have three to six sectors in most cell tower configurations, however a cell tower including any number of sectors might be utilized with the azimuth of each sector no matter how many there are being provided to the plotting tool. Using the provided azimuth information for each sector, the location and boundaries of each sector associated with each cell tower located on the map are determined and plotted by the plotting tool at step 610. Next, at step 609 all of the call data records relating to the cell tower may be obtained. The call data records are used at step 611 to determine where in when calls occurred in a particular area and this information is then plotted on the map. Once all of the cell towers and associated sectors and sector boundaries and call record data have been determined and plotted on the map, the user may also input additional graphical data with respect to activity or points of interest that are located on the map at step 612. This may include information such as the locations from which calls were made or other areas of interest relating to the reason that the plot is being generated. The graphical icons or information with respect to the activity of interest are plotted onto the map at step 614, and the completed plot may be provided for download or printing at step 616.

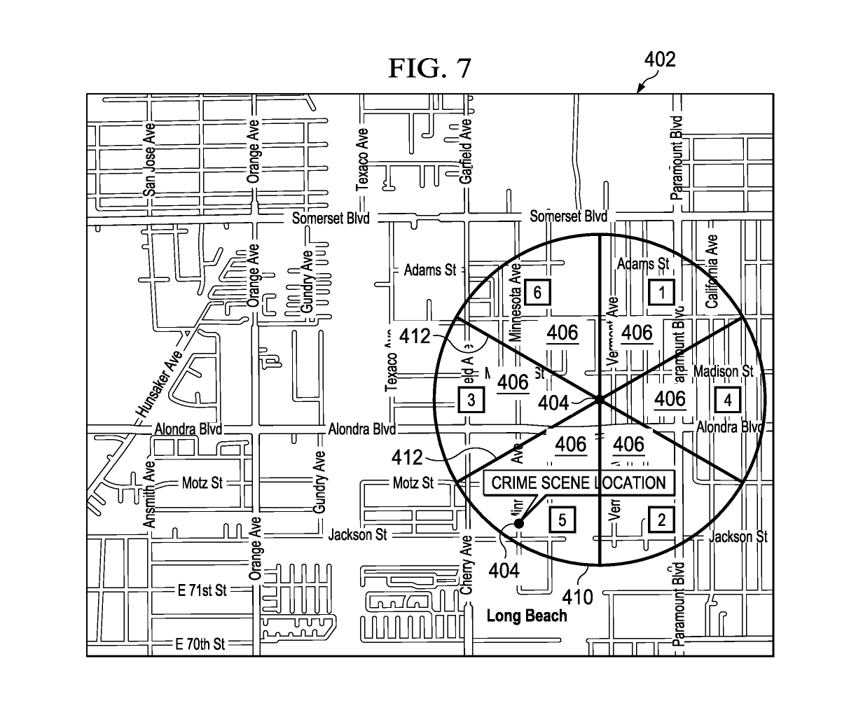

Referring now to FIG. 7, there is illustrated an example of a plot that could be automatically generated according to the system of the present disclosure. The example illustrates a map 702 of an area of Anaheim, Calif. Within the map 402, the location of a cell tower 404 is illustrated. The longitude and latitude of the cell tower 404 places it near the corner of Alondra Boulevard and Vermont Avenue. The cell tower 404 includes six separate sectors 406. Each sector 406 comprises roughly a pie-shaped area having an outer boundary 410 comprising an arc that runs between two side boundaries 412 separating each sector from its adjacent sectors. In this particular example, an additional graphical icon 414 has been added to indicate a crime scene location that occurred within the coverage area of sector five of the cell tower 404.

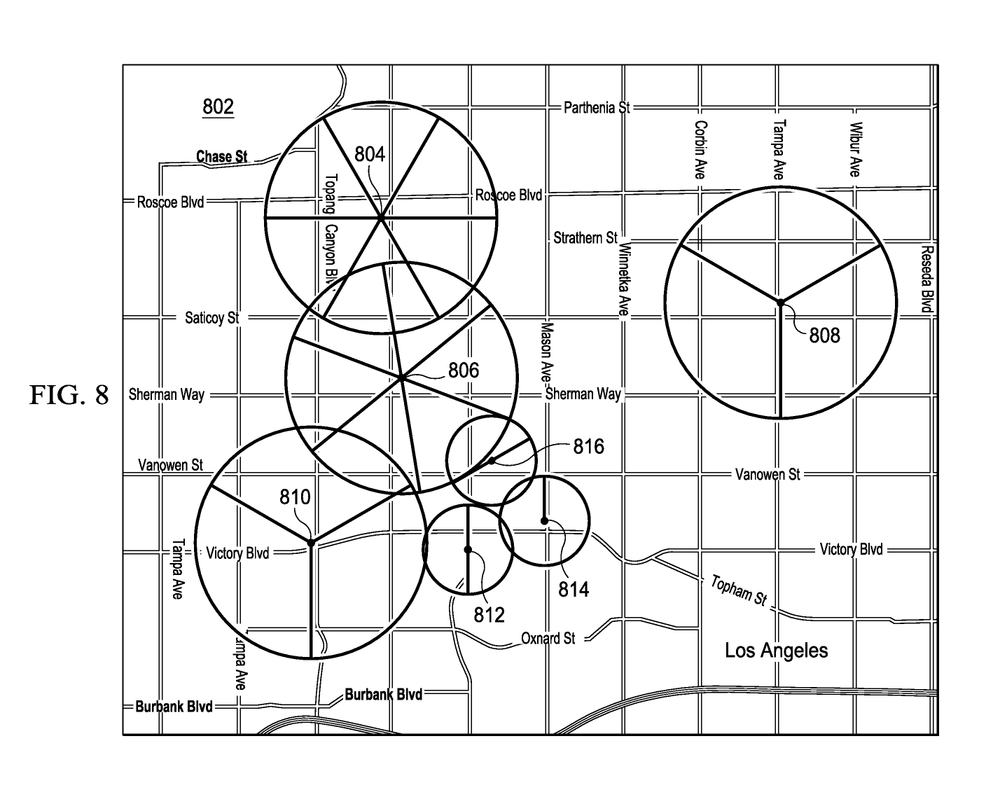

Referring now to FIG. 8, there is illustrated a further example of a plot generated by the automatic cell tower sector plotting tool. In this case, the map 802 comprises an area of Los Angeles, Calif. In this plot, a variety of cell tower locations are noted. In the example of FIG. 8, cell towers 804 and 806 are illustrated. Each of the cell towers 804 and 806 comprise six sector towers and the six sectors associated with each of the towers 804 and 806 are illustrated in the figure. Cell towers 808 and 810 comprise three sector cell towers. These plots have a similar configuration to those of the six sector plots with the exception that only three sectors comprising larger pie-shaped sectors are illustrated with respect thereto. Finally, there illustrated a set of three distributed antenna systems (DAS) 812, 814, and 816. The distributed antenna systems include only a single sector, are Omni-directional and do not have the multi-sector configurations of the other devices. Distributed Antenna Systems have substantially smaller coverage areas. Should DAS become sectored the plotting tool can recognize and account for the boundary lines in the same fashion it would for a standard tower configuration.

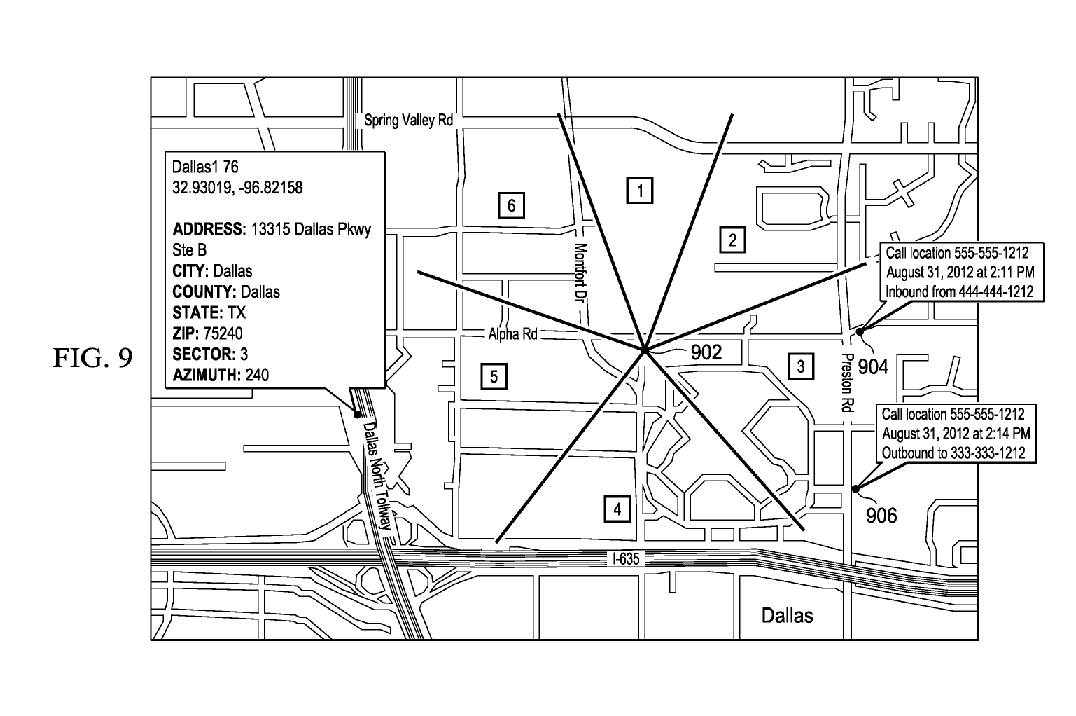

Referring now to FIG. 9, there is illustrated an example of a plot including a cell tower 902 having six different sectors. The plot illustrates a first call location 904 and a second call location 906. The first and second call locations 904 and 906 are determined from call data record information that may be downloaded and used to generate the plots.

Thus, using the above described system and method, the plotting tool application can place a cell tower on a map within a cellular network using the latitude and longitude of the tower. By marking the sectors of the azimuth of each sector, the application may draw the correct boundary lines for each sector and illustrate this on the map. This allows the plotting of towers and sectors for any type of cell tower including distributed antenna systems. The plots generated by the system additionally may contain icons useful for legal or corporate presentations that a user may place within the sectors of the generated plot. This will enable the plot to be used as a visual aid for illustrating call activity relevant to important timeframes that involve calls/text/internet activity related to a particular matter. This program replicates what is presently manually done using one-off calculations and drawings upon maps for court displays.

It will be appreciated by those skilled in the art having the benefit of this disclosure that this automated cell tower sector plotting tool provides an improved manner for generating a graphical plot of cell tower locations and the associated sectors of the cell towers. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. An apparatus, comprising:
a non-transitory, computer readable storage medium containing a set of instructions for a general purpose computer, wherein execution of the set of instructions by the general purpose computer configures the general purpose computer to:
determine a position of at least one cell tower on a map responsive to data indicating a position of the cell tower;
determine boundaries associated with a plurality of sectors associated with the at least one cell tower responsive to an azimuth associated with each of the plurality of sectors;
receive historical call data record data describing historical information with respect to at least one historical call event, the historical call record data originating from a cellular handset usage activity comprising at least one of general packet radio service (GPRS) data, or call detail records (CDR);
determine historical call information related to the at least one historical call event responsive to the at least one historical call data record data originating from the cellular handset usage activity related to the historical call event;
generate a plot of the map including the at least one cell tower and the boundaries associated with the plurality of sectors associated with the at least one cell tower marked on the map and further including a plot of the historical call information of the at least one historical call event.

2. The apparatus of claim 1, wherein the execution of the set of instructions by the general purpose computer further configures the general purpose computer to:
determine a position of a graphical icon on the map responsive to user input relating to the position of the graphical icon on the map; and
generate the plot of the map including the graphical icon on the map.

3. The apparatus of claim 1, wherein the data indicating the position of the cell tower comprises a longitudinal position and a latitudinal position of the cell tower.

4. (canceled)

5. (canceled)

6. The apparatus of claim 1, wherein the plot comprises a graphical representation of the map including the at least one cell tower and the boundaries associated with the plurality of sectors associated with the at least one cell tower marked on the map.

7. The apparatus of claim 1, wherein the execution of the set of instructions by the general purpose computer further configures the general purpose computer to:
determine a position of a graphical icon indicating a location from which a call was made on the map responsive to a call data record relating to a call made to the cell tower; and
generate the plot of the map including the graphical icon indication the location of the call on the map.

8. A method for generating a plot of cell towers and associated sectors on a map, comprising:
determining a position of at least one cell tower on a map responsive to data indicating a position of the cell tower;
determining boundaries associated with a plurality of sectors associated with the at least one cell tower responsive to an azimuth associated with each of the plurality of sectors;
receive historical call data record data describing historical information with respect to at least one historical call event, the historical call record data originating from the cellular handset usage activity comprising at least one of general packet radio service (GPRS) data, or call detail records (CDR);
determine historical call information related to the at least one historical call event responsive to the historical call data record data originating from the cellular handset usage activity related to the at least one historical call event; and
generating a plot of the map including the at least one cell tower and the boundaries associated with the plurality of sectors associated with the at least one cell tower marked on the map and further including a plot of the historical call history of the at least one historical call event.

9. The method of claim 8 further comprising:
determining a position of a graphical icon on the map responsive to user input relating to the position of the graphical icon on the map; and
generating the plot of the map including the graphical icon on the map.

10. The method of claim 8, wherein the data indicating the position of the cell tower comprises a longitudinal position and a latitudinal position of the cell tower.

11. (canceled)

12. (canceled)

13. The method of claim 8, wherein the step of generating further comprises generating a graphical representation of the map including the at least one cell tower and the boundaries associated with the plurality of sectors associated with the at least one cell tower marked on the map.

14. The method of claim 8 further comprising:
determining a position of a graphical icon indicating a location from which a call was made on the map responsive to a call data record relating to a call made to the cell tower; and
generating the plot of the map including the graphical icon indication the location of the call on the map.

15. A system for generating a plot of at least one cell tower and associated sectors on a map, comprising:
a server connected to a network, the server configured to:
receive a request for generation of the plot of the at least one cell towers and associated sectors on the map from a web browser connected to the network;
determine a position of at least one cell tower on the map responsive to data indicating a position of the cell tower;
determine boundaries associated with a plurality of sectors associated with the at least one cell tower responsive to an azimuth associated with each of the plurality of sectors;
receive historical call data originating from the cellular handset usage activity describing historical information with respect to at least one historical call event, the historical call record data comprising at least one of general packet radio service (GPRS) data, or call detail records (CDR)
determine historical call information related to historical call events responsive to historical call data records originating from the cellular handset usage activity;
generate the plot of the map including the at least one cell tower and the boundaries associated with the plurality of sectors associated with the at least one cell tower marked on the map and further including a plot of the locations historical call information associated with the historical call data events on the map; and
transmit the plot of the at least one cell tower on the map to the web browser connected to the network.

16. The system of claim 15, wherein the server is further configured to:
determine a position of a graphical icon on the map responsive to user input relating to the position of the graphical icon on the map; and
generate the plot of the map including the graphical icon on the map.

17. The system of claim 15, wherein the data indicating the position of the cell tower comprises a longitudinal position and a latitudinal position of the cell tower.

18. (canceled)

19. (canceled)

20. The system of claim 15, wherein the plot comprises a graphical representation of the map including the at least one cell tower and the boundaries associated with the plurality of sectors associated with the at least one cell tower marked on the map.

21. The system of claim 15, wherein the server is further configured to:
determine a position of a graphical icon indicating a location from which a call was made on the map responsive to a call data record relating to a call made to the cell tower; and
generate the plot of the map including the graphical icon indication the location of the call on the map.

22. A system for generating a plot of at least one cell tower and associated sectors on a map, comprising:
a mobile application located upon a mobile device for generating at least one request relating to generation of the plot of at least one cell tower and associated sectors on the map and transmitting the request over a mobile communications network;
a server connected to the mobile communications network for receiving the at least one request over the mobile communications network;
wherein the server and the mobile application work together to:
determine a position of at least one cell tower on the map responsive to data indicating a position of the cell tower;
determine boundaries associated with a plurality of sectors associated with the at least one cell tower responsive to an azimuth associated with each of the plurality of sectors;
receive historical call data record data describing historical information with respect to at least one historical call event, the historical call record data originating from the cellular handset usage activity comprising call detail records (CDR);
determine locations for the at least one historical call event responsive to the historical call data records originating from the cellular handset usage activity; and
generate the plot of the map including the at least one cell tower and the boundaries associated with the plurality of sectors associated with the at least one cell tower marked on the map and further including an indication of the location associated with the at least one historical call event.

23. (canceled)

24. The system of claim 22, wherein the data indicating the position of the cell tower comprises a longitudinal position and a latitudinal position of the cell tower.

25. The system of claim 22, wherein the server is further configured to:
receive call data record data describing information with respect to at least one call; and
generate the plot of the map to include a graphical representation associated with the call record data.

26. (canceled)

27. The system of claim 22, wherein the plot comprises a graphical representation of the map including the at least one cell tower and the boundaries associated with the plurality of sectors associated with the at least one cell tower marked on the map.

28. The system of claim 22, wherein the plot is generated at the server and transmitted from the server to the mobile application.

29. The system of claim 22, wherein the plot is generated at the mobile application responsive to data from the server.

30. The system of claim 22, wherein the server and the mobile device further work together to:
determine a position of a graphical icon indicating a location from which a call was made on the map responsive to a call data record relating to a call made to the cell tower; and
generate the plot of the map including the graphical icon indication the location of the call on the map.
